(19) United States
(12) Patent Application Publication
(10) Pub. No.: US 2025/0225814 A1
(43) Pub. Date: Jul. 10, 2025

(54) VISUAL ATTENTION TRACKING AND ANALYTICS SYSTEM

(71) Applicant: ELM, Riyadh (SA)

(72) Inventors: Arshad Ali KHAN, Riyadh (SA); Athul MATHEW, Riyadh (SA); Riad SOUISSI, Riyadh (SA)

(73) Assignee: ELM, Riyadh (SA)

(21) Appl. No.: 19/011,087

(22) Filed: Jan. 6, 2025

Related U.S. Application Data
(60) Provisional application No. 63/617,870, filed on Jan. 5, 2024.

(51) Int. Cl. G06V 40/18; G06V 10/25

(52) U.S. Cl. CPC G06V 40/18; G06V 10/25

(57) ABSTRACT

A system and computer-implemented method of attention tracking and includes obtaining a video stream of a predefined area, the predefined area including at least one person, detecting a person image of the person in the predefined area, detecting objects in the predefined area, extracting gaze points and determining a possible attention target of the detected person, continuously tracking of attention direction of the person, determining in real time an attention score based on the attention target, and dynamically displaying, in a display device, the video stream together with attention information, including the attention score, for the person. The system and method provides real time determining of a personalized attention score for an individual student or an overall attention score for a group of students attending a lecture in a classroom environment.

### CROSS-REFERENCE TO RELATED APPLICATIONS

This application claims the benefit of priority to provisional application No. 63/617,870 filed Jan. 5, 2024, the entire contents of which are incorporated herein by reference.

### BACKGROUND

### Technical Field

The present disclosure is directed to an attention tracking and estimation pipeline. The pipeline encompasses dedicated pathways for processing head, scene, and face orientation information to detect and pinpoint people's attention to target points in real-time as well as in offline video streams.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In the fast-changing landscape of artificial intelligence and computer vision, the ability to understand human visual perception has emerged as a pivotal area of research. One key aspect of this understanding is the estimation of visual attention in public places of interest. Attention estimation entails leveraging cutting-edge technologies to analyse and comprehend where individuals are looking, what they are paying attention to, and, by extension, what they are interested in. This technology holds immense potential across multiple domains, from enhancing student-teacher engagement in a classroom or lecture theatre, and understanding the attention levels in an art gallery or a conference session to improving user experiences in various applications requiring the computation of visual attention levels.

With the advent of deep learning, neural network-based models, and now visual-language Large Language Models (LLMs), the AI Computer Vision field has become increasingly adept at recognizing objects, tracking movements, and analyzing fast-changing scenes in the wild as well as constrained areas. In this context, estimating visual attention using computer vision is a natural progression, driven by the need to enhance human-machine interactions more intuitive, intelligent, and context-aware.

The significance of this technology is further underscored by its potential to revolutionize industries such as education, marketing, advertising, healthcare, automotive, gaming, and more. For instance, in healthcare, attention estimation can be instrumental in developing assistive technologies for individuals with disabilities, while in education, it can help out institutions to optimize teaching methods in classrooms and reduce the gap between fully attentive and less attentive students. Moreover, the gaming industry can use this technology to create more immersive and responsive experiences, and marketing can leverage it for more targeted and effective campaigns such as using digital signboards to receive attention from pedestrians and motorists alike.

Human beings have a remarkable capability to understand each other as an attention target, understand whether a person is looking at a particular object and determine the attention of others. Attention estimations are an active research area and can have a wide range of applications, including student-teaching attention analytics, educational assessment, human-computer interaction, and treatment of patients with cognitive or neurological disorders such as early diagnosis of ADHD (Attention Deficit Hyperactivity Disorder) in children and so on. ML and deep learning technologies offer powerful tools to process and analyze data from various sources, such as eye-tracking, facial expressions, head positions, physiological responses, and user behaviour in various interactive environments such as shopping malls, student classrooms and lecture theatres etc. By leveraging these techniques, it is possible to extract valuable insights into the visual, cognitive, and emotional states of individuals during different activities.

Typically, visual attention estimation utilizes eye or facial images of a person to estimate the direction of gaze for the person and estimate the target point. These methods utilize the facial features of the person, such as the eyes, nose, and mouth, to infer the three-dimensional orientation (i.e. Yaw, Pitch and Roll) of the face and regress the gaze direction. These methods can be less accurate, especially in challenging conditions such as low lighting or when the person is wearing glasses. Typical gaze target and attention estimation systems often require a calibration step, where the user is asked to look at various points before usage of such a system. Also, such attention tracking systems are constrained because these systems are designed to monitor the attention of one person when the person is well situated within the
confined space of monitoring for the gaze tracking system. An example of such a system is
a driver attention or fatigue detection system in vehicles where the system is expected to monitor the gaze of the driver seated in the driving seat.

Attention target detection and attention estimation of a given person in an image or video sequence involves learning the relationship between the relative position of the person within the scene and the scene objects that lie within the field of view of that person. A robust and scalable attention target assessment system is needed to identify the salient objects that people are likely to look at. While significant progress has been made in gaze target detection and attention estimation from images, incorporating multi-modal contextual cues remain a challenge. Such cues can enhance the accuracy and robustness of attention target and estimation but reconstructing these cues from 2D images/video streams in multiple scenarios is a difficult challenge. This problem is further exacerbated when detecting the gaze behaviour of multiple people while they are looking at multiple points e.g., a smartphone screen, book, notebook, at another participant, towards the camera or the teacher/instructor. To distinguish attention and in-attention based on clear discriminants is a challenging research problem which demands a comprehensive understanding of the overall atmosphere in a classroom or public place of interest where the focus remains on engagement-based learning or training. An accurate estimator determines the quality of the pedagogical approach towards quality teaching to benefit all participants regardless of the positions of participants, distance from the attention target point or other environmental factors.

The current status of visual attention target estimation using AI computer vision in Saudi Arabia and beyond reflects a dynamic landscape with significant potential and transformative impacts across various sectors. Attention estimation technologies are increasingly being adopted across diverse sectors e.g., educational establishments, marketing and advertisement, healthcare and retail industry. Notably, the retail industry is using these systems to analyze customer interactions and optimize store layouts for enhanced shopping experiences. In education, these technologies are applied to gauge student engagement in e-learning platforms, offering valuable insights for educators and institutions.

Some conventional approaches require accurate localization of the eye for estimation of attention targets. However, this is an additional overload in terms of overall attention computation. It also limits the system performance because eyes may be occluded or only partially visible in real-life in the wild configurations. Another conventional technique or method used in attention detection and estimation is joint multi-party visual focus of attention (VFOA) recognition from head pose and multi-modal contextual cues.

Recognizing VFOA jointly for participants introduces context-dependent interaction models that account for group activity and social communication patterns. Independent VFOA recognition for each participant may fail to capture the nuances of collaborative or social attention. Incorporating multimodal cues, such as contextual and group interaction data, can enhance the robustness of attention estimation systems compared to traditional eye or head pose detection methods.

Accordingly, it is one object of the present disclosure to provide a method and system for attention analysis in video streams. Rather than independently recognizing the VFOA of each participant from his head pose, an object is to recognize participants' VFOA jointly to introduce context-dependent interaction models that relate to group activity and the social dynamics of communication. A further object is a more holistic understanding of attention in shared environments. A further object is joint recognition models provide a more accurate depiction of attention distribution within a group context.

### SUMMARY

An aspect is a system for attention tracking and analytics, that can include a video stream storage device for storing a video stream of a predefined area, the predefined area including at least one person; a tracking and analysis server configured with a plurality of object detectors, including a person detector for detecting person images of the at least one person in the predefined area, an object detector for detecting objects in the predefined area, and a gaze module for extracting gaze points and analyzing the gaze points to determine a possible attention target of the at least one person in the person images; an attention calculation module for continuous tracking of attention direction of the at least one person and real-time determining of an attention score based on the gaze patterns; and a display device for dynamically displaying the video stream together with attention information, including the attention score, for the at least one person.

An aspect is a computer-implemented method of attention tracking and analytics, that can include storing, in a video storage device, a video stream of a predefined area, the predefined area including at least one person; detecting a person image of the at least one person in the predefined area; detecting objects in the predefined area; extracting gaze points and determining a possible attention target of the detected person; continuously tracking of attention direction of the at least one person; determining in real time an attention score based on the gaze patterns; and dynamically displaying, in a display device, the video stream together with attention information, including the attention score, for the at least one person.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a block diagram of an attention tracking and analytics system, in accordance with an exemplary aspect of the disclosure;

FIG. 2 is a flowchart of a method of attention tracking and analytics, in accordance with an exemplary aspect of the disclosure;

FIG. 3 is an overview of the attention detection and visualisation system in accordance with an exemplary aspect of the disclosure;

FIG. 4 is a block diagram of system architecture showing the orchestration of various modules, in accordance with an exemplary aspect of the disclosure;

FIG. 5 is a screenshot of a dashboard UI, in accordance with an exemplary aspect of the disclosure;

FIGS. 6A to 6D are screenshots from various places of interest where the system can be trialed after deployment, in accordance with an exemplary aspect of the disclosure;

FIG. 7 is an illustration of a non-limiting example of details of computing hardware used in the computing system, in accordance with an exemplary aspect of the disclosure;

FIG. 8 is an exemplary schematic diagram of a data processing system used within the computing system, according to certain embodiments;

FIG. 9 is an exemplary schematic diagram of a processor used with the computing system, according to certain embodiments; and

FIG. 10 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Attention and engagement estimation in various domains, including education, marketing, and retail, is crucial for understanding and optimizing interactions with individuals. Aspects of this disclosure are directed to a system and method for visual attention tracking and analytics (referred to as Visual Attention Tracking and Analytics System VATAS), which incorporates Artificial Intelligence (AI) and Computer Vision (CV) techniques for the automated assessment of attention and engagement levels in classrooms, training sessions, conference booths, retail environments and other areas of public interest, such as museums and art galleries.

Classroom and events attention estimation helps in understanding the level of participants'/student's attention, student-teacher interaction in a classroom, visitors' interest in certain artefacts in museums, exhibitions, customer's interest in a retail shopping place, to name a few. Aspects of the system include dedicated pathways for processing head, scene, and face orientation information to detect and pinpoint people attention to target points in real-time as well as offline video streams. An aspect is modalities that are fused to pinpoint the gaze target of any person in a scene and compute overall attention and fixation points between multiple people and a target point. Furthermore, an aspect is an end-to-end attention estimation system with a fully customized infrastructure along with a dashboard system to facilitate the client with a turnkey solution ready to deploy and launch at different sites.

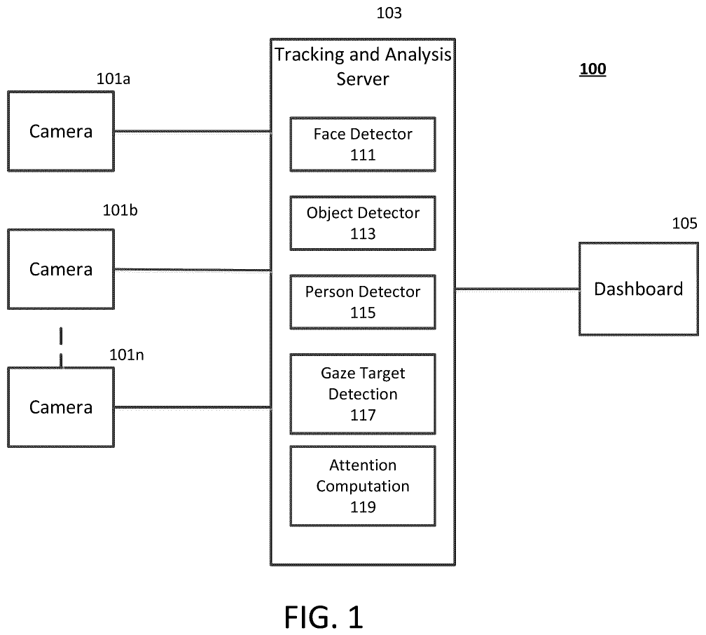

FIG. 1 is a high-level block diagram of the attention tracking and estimation (VATAS). VATAS is a pipeline designed to monitor and analyse attention in real-time environments such as classrooms, retail settings, and public events. The system 100 integrates several components/modules, each fulfilling a critical role in processing and interpreting visual data to determine where attention is pinpointed (objects of interest) or fixated. The system 100 includes algorithms for extraction of multiple types of information from a scene (captured through various types of cameras 101a-101n) in a static or continuous stream, where a person's attention is pinpointed to an Object of Interest (OOI) or wherever he or she is looking at. It involves determining the specific point or area a person is looking at in an image.

The cameras 101a-101n are arranged to capture non-overlapping or partially overlapping field of view. The cameras can be fixed position cameras mounted in a room, such as a classroom, and may include a direction changing function. Change in direction may be by way of motor or manual repositioning. In some embodiments, cameras may be remotely controlled independently, or controlled through a central control device. A central control device may include a computer device, such as a smartphone, tablet, desktop, or other computing device. The central control device may itself be configured with a cameral setup and camera control module. Additional cameras may be added and can include mobile cameras, optionally mounted to a stand or handheld. The resolution of the cameras 100a-100n can vary between each camera, or a set of the cameras can be of a common resolution.

In some embodiments, the cameras 101a-101n can be configured with lens systems or interchangeable lenses. Lens systems can include wide-angle lenses, zoom lenses, and fisheye lenses.

In preferred embodiments, the cameras are for 2D image capture. However, in some embodiments, some of the cameras (e.g., pairs of cameras) can be configured for 3D image capture.

In some embodiments, cameras 101a-101n can be centrally turned on and off, for example, through a central cameral controller, to switch between cameras in order to capture a single video stream made up of image frames from one camera at a time.

In some embodiments, one or more cameras may be arranged to focus on an area and capture a video stream for the area.

The system incorporates an object detector 113, person detector 115 and face detection model 111, where the combination of these detectors is configured for back-of-head detection of the person in the image to extract additional contextual cues. This feature aids in identifying the attention target accurately and improves reliability of an attention estimation score in a variety of conditions and environments. Information from the three modalities (Object detection, Person Detection and Face Detection) are relayed back into the gaze target detection module 117 which acts as input to an overall attention estimator 119, in real-time and offline streams. The combination of the detectors in the system 100 enables identification of the attention target irrespective of the facial orientation such as frontal face and profile face.

The person detector 115 is trained on a large dataset of images to identify human figures within a picture or video by analyzing features like body shape, clothing, and facial characteristics. to achieve high accuracy in recognizing people in various poses and lighting conditions. This allows the person detector 115 to distinguish humans from other objects in the scene. Once a person is detected, the person detector 115 generates a bounding box around the identified area on the image to indicate the person's location.

The face detector 111 is trained on a custom dataset including face profiles from a variety of data samples (e.g., faces of various sizes, smaller and larger faces). The face detector 111 can detect a face based on face features including the location of eyes, nose and mouth. In some cases, other face features may be identified, including scars or other unique facial features.

The object detector 113 deals with detecting instances of semantic objects of a certain class (such as humans, desks, display devices, or communication devices, to name a few) in digital images and videos. The object detector 113 may be trained with images having a bounding box drawn by a human.

The gaze target detection 117 and attention estimator 119 architecture beats the state of the art (SOTA) attention scores while tested on public datasets in addition to achieving a very good accuracy on application levels using multiple use cases. The system has been evaluated on public and custom-collected datasets which entails the benchmarking comparison of the approach's performance with other methods and demonstrates its effectiveness. The gaze target detection module 117 and attention estimation module 119 perform well above the existing approaches in terms of a full-fledged attention target detection system.

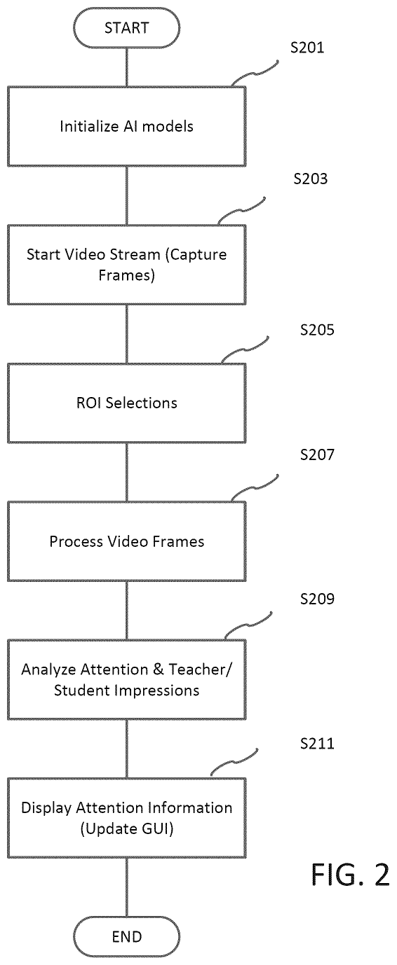

FIG. 2 is a flowchart of a method of attention tracking and analytics. In step S201, the AI models are initialized. In step S203, a video stream continuously captures frames from an Real Time Streaming Protocol (RTSP) camera or offline video using a dedicated video streaming thread. In step S205, a region of interest (ROI) selection tool initially captures the student and teacher territorial coordinates and stores them in the ROI object for detection and attention computation. In step S207, a streaming display displays frames with visualisation and constantly updates various counters and visualisations based on detected objects (phones, chairs, tables, whiteboards etc), all visible people in the frames/video stream, faces of persons and gaze points. In step S209, attention analysis starts analysing the attention-related metrics using object detections, face detections, attention point coordination student-teacher, teacher-student, student-objects, and students-other impression counts. The Attention analysis module also determines if the attention or gaze point is not on a book or object, it may either be on a student's ROI or a teacher's ROI. Attention score is computed by associating objects that contribute positively or negatively towards human attention. For instance, a student looking at his/her phone constantly during lecture time contributes towards negative attention. Similarly, in the context of retail use-cases, the interest level of customers towards products are estimated with the dwell time and impression counts towards products and shelves. In step S211, the graphics overlay or Display Attention module creates a graphic overlay on the frames including rectangles, lines, circles and visualisations of attention-related metrics for a clear-to-understand attention level.

The motivation for conducting visual attention estimation using AI computer vision is driven by a range of factors which include but are not limited to:

Student-teacher interaction improvement (Enhanced Human-Machine Interaction): One of the primary motivations is to create intelligent systems that can understand and respond to human gaze and attention, or in-attention thus making interactions more natural, seamless, and intuitive. This has the potential to significantly improve the way people interact with technology, especially in an educational setup where the quality of teaching across the classroom matters a lot.

Accessibility and Inclusivity: Visual attention estimation can be a game-changer for individuals with disabilities, offering new means of communication and control over digital devices, which is both socially and technologically empowering.

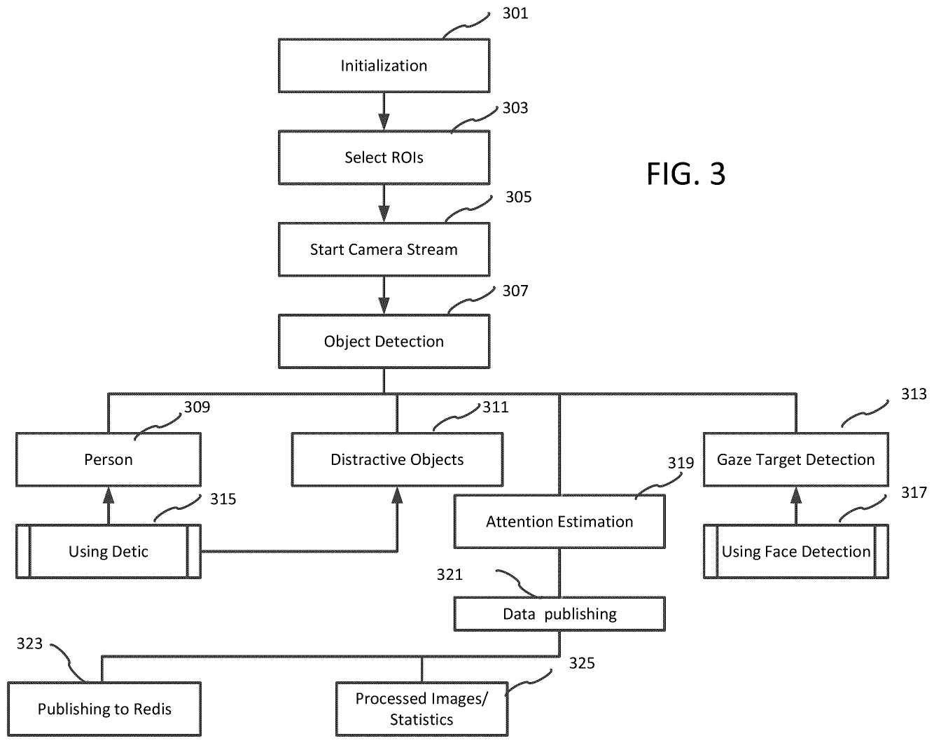

FIG. 3 is an overview of the attention detection and visualisation system. More specifically, FIG. 3 illustrates the components comprising an embodiment of the disclosure, and how these components work together to determine attention detection and estimation. The initialization module 301 starts from an input image stream which captures real-time video from a specified source e.g. video file or RTSP link. The live feed serves as the input for the attention estimation process. The ROI module 303 is responsible for the Region of Interest (RoI) management which specifies predefined regions within the video frames or RTSP stream. These ROIs help focus the analysis on particular areas such as student desks in a classroom or specific product shelves in a retail store or shopping mall etc. A camera stream module 305 is used in obtaining video. An object detection component 307 employs multiple detectors such as object detector, person detector, and face detector,

The detectors can be implemented with a machine learning model that can detect objects in an image, including, but not limited to a multilayered perceptron, in particular most types of convolutional neural networks (CNN). In a preferred embodiment, the detectors are implemented with a version of You-Only-Look-Once (YOLO). The YOLOv7 is an example version of YOLO which can be custom-trained for person detection and heterogenous YOLO face detection algorithms.

The YOLOv7 network is structured into four key components, i.e., an input, a backbone, a neck, and a prediction. The YOLOv7 network employs a mosaic enhancement technique during data augmentation, which combines random cropping, zooming, and other transformations to diversify background of the camera view image and improve robustness of the YOLO network. For person detection, the YOLOv7 network requires four input parameters, i.e., the camera view image, the YOLOv7 network configuration file, the trained YOLOv7 network weights, and a text file containing a class label, e.g., ‘person’. The YOLOv7 network configuration file includes information such as number of layers, an image type of the camera view image, and the like. A process for person detection by the YOLOv7 network begins by obtaining the width (w) and the height (h) of the camera view image. Next, colors for the class label (i.e., the person) and the bounding boxes are set, which will be used to annotate detected objects. Further, using the YOLOv7 network configuration file and trained YOLOv7 network weights, the YOLOv7 network is initialized, creating a deep CNN.

YOLO v7 includes a number of enhancements compared to previous versions. A key enhancement is the implementation of anchor boxes. These anchor boxes, which come in various aspect ratios, are utilized to identify objects of various shapes. The use of nine anchor boxes in YOLO v7 enables it to detect a wider range of object shapes and sizes, leading to a decrease in false positives.

In YOLO v7, a loss function called “focal loss” is implemented to enhance performance. Unlike the standard cross-entropy loss function used in previous versions of YOLO, focal loss addresses the difficulty in detecting small objects by adjusting the weight of the loss on well-classified examples and placing more emphasis on challenging examples to detect.

The detectors in the present disclosure work collaboratively as part of a detection pipeline to identify and locate key entities, like people, faces, and objects in real time. All this ensures that the detection of relevant objects such as students, or retail customers are analyzed within the specified ROIs. Furthermore, person classification 309 is determined by leveraging detection results and ROI constraints. Individuals in the scene are categorized as “students” or “teachers/lecturers” (in a classroom) or as “customers” in a retail environment. This classification is crucial for subsequent gaze and attention analysis.

The gaze target detection module 313 or gaze target prediction component predicts the direction of individuals' gazes, determining whether they are focused on the teacher, or specific objects like books or products. In gaze target detection, the detector identifies and tracks the point of an object that a person is looking at with their eyes (using head position). The gaze target detection module aims to determine where a person's gaze is directed within a visual scene.

A gaze detector determines the focus point of individuals within the video stream. The focus points are collected corresponding to each detected person, a detected face, and one or more detected objects. At any point in time, a detected person is predicted to be gazing in a direction of one of the detected objects, or moving between gaze directions. The target of the person's gaze is determined using the determined focus points for generating a heatmap identifying one or more potential targets of the person's gaze direction in the image, each potential target being associated with a probability score representing the likelihood that the subject target is the target of the person's gaze.

The outcome from this predictive real-time analysis of gaze direction is used for the assessment of student-teacher or customers-product attention estimation or computation 319.

A distraction module 311 predicts students looking around, i.e., not focusing attention on the teacher or specific objects, and instead focusing on another person or some other distraction.

The data visualization of the estimated attention with respect to several potential attention points, can be displayed on a display device as gaze information overlayed onto the video feed for real-time monitoring. Gaze information can include, but is not limited to, a line between a subject person and another person or object, a heatmap for a target, and probability of a gaze target. All this aids in the interpretation of the attention estimation (VATAS's) system output in multiple use cases including classroom and retail environments.

In addition, the publication and analytics components in FIG. 3 includes a stream publisher 321 and a Redis connection 323. Redis (REmote DIctionary Server) is an open source, in-memory, NoSQL key/value store that is used primarily as an application cache or quick-response database. The publication module 325 aggregates and publishes attention-related statistics, such as the proportion of students' focusing on the teacher or customers looking at specific products. The publication module 325 can transmit attention analytics, such as gaze-at-teacher, student count, and attention scores, to an external dashboard system. In some embodiments, the dashboard can be customized to display desired analytics results, such as graphs or real time video. An overall attention score for example, in the VATAS system, can provide a quantified measure of engagement in real-time as well as in offline videos.

The VATAS system is applicable to several use cases including classroom environments, retail environments, as well as public events. A preferred embodiment is application of the VATAS system to a classroom environment.

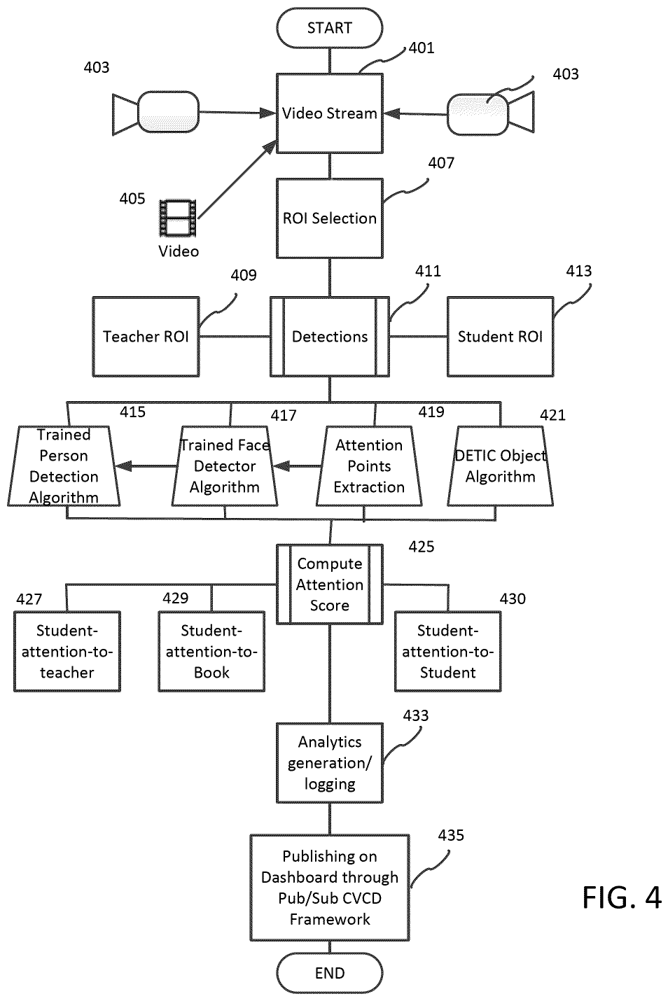

FIG. 4 is a diagram of a system architecture showing the orchestration of various modules in the VATAS system for a classroom environment. The diagram comprehensively elucidates the overall methodology of attention subject and target object detection, localisation, mapping subject to fixation points and pin-pointing gaze points (gaze directions) and finally estimating (through estimation algorithms) and publishing the aggregate attention levels through a dedicated publishing network infrastructure. The system includes dedicated pathways for processing head, scene, and face orientation information to detect and pinpoint people attention to target points in real-time as well as offline video streams. The system includes multiple modalities that are fused to pinpoint the gaze target of any person in a scene and compute overall attention and fixation points between multiple people and the target point. Furthermore, the system performs an end-to-end attention estimation by way of a fully customized infrastructure along with a dashboard system to facilitate the client with a turnkey solution ready to deploy and launch at different sites.

### Attention Estimation in an Educational Classroom.

Attention estimation in classrooms using AI and Machine Learning technologies aims to incorporate AI technologies to understand the classroom's culture and improve upon the students-teacher interaction and engagement. The primary goal is to identify potential problems for in-attention and enable the educational institutions to monitor attention in a non-intrusive manner, address the lack of attention among certain students in a specific subject class or training session etc.

Classroom and events attention estimation helps in understanding the level of participants'/students' attention in a classroom, training hall, retail malls, conference hall etc. The system incorporates cameras 403 positioned around the classroom to capture video 401. The video 401 may also be obtained from a previous stored video 405. The system has detections modules 411 including head-pose and face detectors 417 along with object detectors 421, ROI (Region of Interest) selection module 407 and points of attention direction 419 to pin the person in the scene to an attention target (where he/she is looking at). A selected ROI can include a teacher ROI 409 or a student ROI 413,

The system incorporates a fully trained person object detector 415 into the pipeline using a custom dataset comprising of data from various classrooms (several intrinsic/extrinsic variations) with synthetic data inclusion as well.

The system utilizes a detector with image classes (DETIC) object detector 421 which can identify 21,000 different object classes in the world with strong accuracy, including for objects that were previously challenging to detect. A DETIC object detector 421 can use image-level labels to easily train detectors.

The system incorporates a fully trained face detector 417 to ensure the detection of nearer and farther faces in a classroom with equally distributed accuracy for better aggregate attention estimation.

For purposes of performance evaluation, a ground truth (GT) benchmark has been prepared through highly accurate labelling and annotation by experts in the V7lab company in the US.

An attention score computing module 425 involves person-to-object tagging/mapping 411 including students-to-others (mobile phone, outside), students-to-teacher 427, students-to-book 429 and students-to-student 430 scenarios are incorporated into the Visual Attention Tracking and Analytics System (VATAS) to compute the attention and in-attention for multiple people in a classroom or lecture room.

### Selection of Regions and Persons of Interest

The system 100 facilitates users to draw rectangles on an image to define different regions of interest like the student's desk and the teacher's area. Assuming that the teacher and students occupy a certain spatial space in a classroom, training room or lecture theatre, the system enables the user to create Teacher ROI and Student ROIs before the attention application is launched. The ROI module keeps track of stored regions for the attention detector and attention computation module which keeps track of these regions as long as the video stream is received by the AI module. The attention computation continues in real-time as well as gets logged for the Dashboard to be used by multiple users at any time of the day.

OOI (Objects of Interest) detection includes people, projectors, windows, mobile phones, laptop/devices screens, black board, white board, book, paper.

The system 100 leverages computer vision to detect and track devices like computers, tablets, and mobile phones. The system includes an attention analytics module 433. The attention analytics module 433 analyzes gaze points in order to narrow down the student's focus. Attention scores are evaluated using conditions of positive attention offset by conditions of negative attention. For example, a real time attention score may be calculated as follows.

Positive Attention: Gaze directed towards designated devices (computers, tablets) is rewarded with positive attention scores.

### Negative Attention

Mobile Phone Usage: Detection of mobile phone gaze triggers negative scores and the transmission of immediate alerts to invigilators.

Distracted Gaze: Students looking around, potentially seeking answers from others, also incur negative scores and the transmission of real-time alerts.

In the example, a proactive system, equipped with real-time alerts, empowers invigilators to address potential cheating attempts promptly, ensuring fair and equitable examinations for all students.

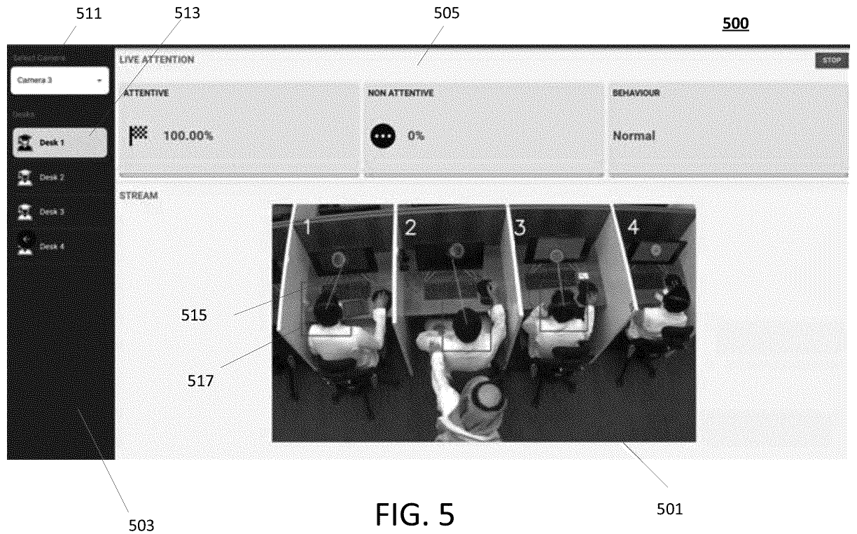

FIG. 5 is a screenshot of a dashboard UI. One embodiment is a student monitoring solution that provides personalized reports at exam conclusion. These reports detail student attention scores throughout the exam. The dashboard 500 can include a live video stream 501, a task bar 503 and an attention reporting area 505. The task bar 503 can include a camera selection function 511 that can be used to select the camera for display in the video stream 501. The task bar 503 can include a function to select an area for which attention scores are calculated for, and displayed in the attention reporting area 505. The video stream 501 may be augmented with an attention direction line 515 to show the direction of attention of a person 517.

Algorithm 1 is pseudocode for the extraction and processing of core information (in a scene image or video sequence) from the input and using sub-algorithms e.g. face detection, trained person detector, DETIC object detection and gaze point extraction algorithm. The process runs continuously for every single scene until there are no frames left in a video sequence.

Algorithm 1: Attention target detection process flow

while there is an image/stream frame do

| \| | Input : video stream or series of images | | |
|---|---|---|---|
| \| | Initialize AttentionDetection (roi..id, attention..x, attention..y) | | |
| \| | | Initialize AttentionTarget class: | |
| \| | | | elm..Attention= AttentionSpatialClass |
| | | | (pre_trained_weights) |
| \| | | | transform.reSize( ) |
| \| | | | transform.toTensor( ) |
| \| | | | transorm.Normalize( ) |
| \| | | PredictAttentionTarget ( ): using BaseDetector | |
| \| | | bd= Base.Detector(head, headChannel, frames) | |
| \| | | faceDetector= TrainedYoloFace( ) | |
| \| | | Predict..AttentionPoint( ): | |
| \| | | while there is a detected face do | |
| \| | \| | | crop head region from frame |
| \| | \| | | create headChannel tensor |
| \| | \| | | [Transform head, headChannel and frame to list] |
| \| | \| | | if head in the list then |
| \| | \| | \| | pass head, frame and headChannel tensor to elm |
| | | | Attention Model |
| \| | \| | \| | process output heatMap to obtain AttentionPoints |
| \| | \| | \| | Return AttentionPoints |
| \| | \| | \| | Continue |
| \| | \| | | else |
| \| | \| | \| | Break ; |
| \| | \| | | end |
| \| | \| | | iterate... |

| | |
|---|---|
| \| | end |

end

In the algorithm, an attention model takes as input a head region, a frame, and a head channel and outputs a heat map representing attention probabilities. The heat map is used to obtain potential attention points. The disclosed system incorporates a generic ROI-based people and object detection approach to associate objects and attention points for computation of an aggregate attention score. An overall attention computation algorithm continuously produces attention scores in places of interest. In one embodiment, the attention computation is performed within a teacher-student learning environment. In an embodiment, the disclosed system determines a personalized attention score for an individual student or an overall attention score for a group of students attending a lecture in a classroom environment.

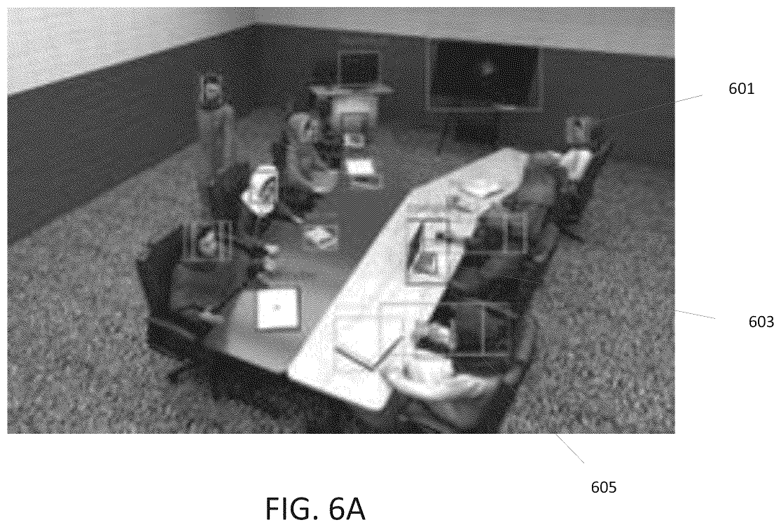

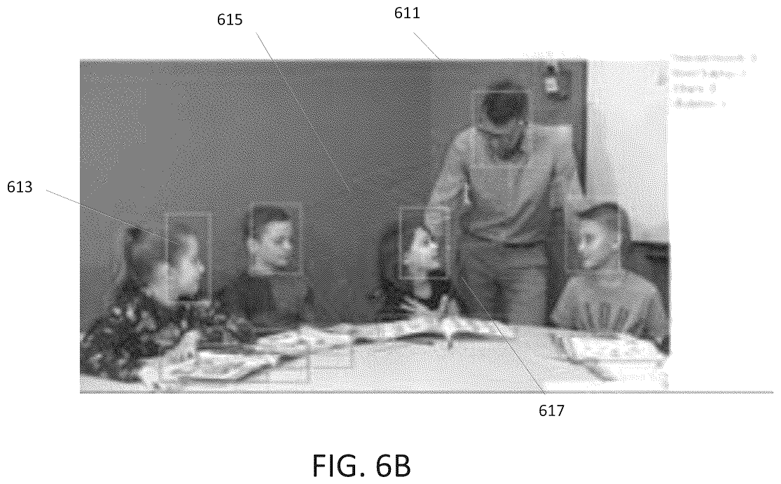

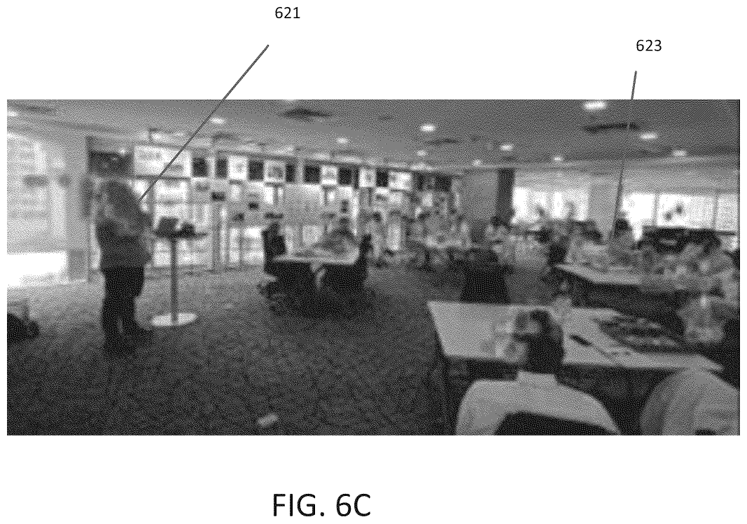

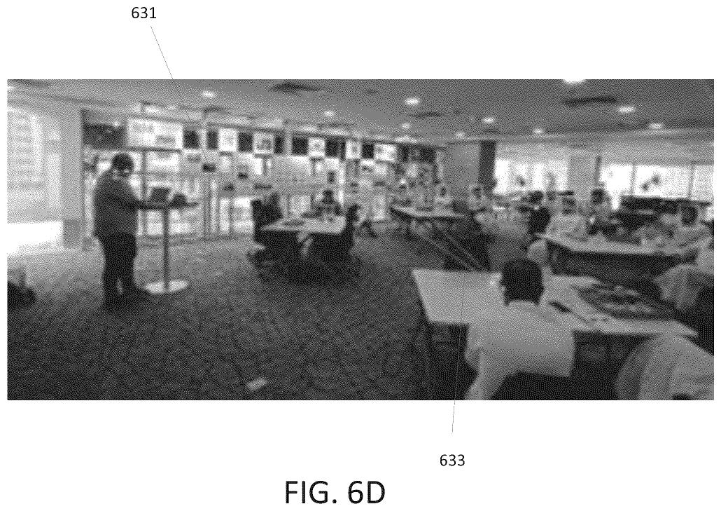

FIGS. 6A to 6D are screenshots from various places of interest where the system has been trialed after deployment. The screenshots in FIGS. 6A to 6D are from LIVE demos of User Interface (UI) to show attention status in various environments including research labs, a training room, a classroom and a museum. It can be seen that after having trained the person detection, face detectors and attention points models on a variety of data, the algorithms generalize well on different attention regions of interest (classrooms, museums, exhibitions, exam centre). The trials have been conducted using a single RTSP camera and a 3080Ti GPU machine for several days and the system achieved the most attention benchmarks. It should be understood that active collaboration with academia and participating industrial clients can be performed to further improve and refine the gaze target prediction and attention estimation model performance using real-time scenarios like student-teacher engagements, customers-shopping behaviours in retail and visitors' interaction with artefacts in a museum.

Regarding FIG. 6A, person detector 415 and object detector 421 detects person head 601 and object 603, respectively. It can be seen that a person head 605 can be detected by the person detector even when the face is not visible in the image.

Regarding FIG. 6B, the face detector 417 can detect the faces of the students 613 and head of the teacher 611. Attention points detector 419 determines the direction of attention lines 615 of each student, as well as the direction of attention of the teacher 617.

Regarding FIG. 6C, the live video stream can be augmented with a gaze attention heatmap. FIG. 6C illustrates the VATAS capacity to monitor business or training session meeting to estimate the engagement index of participants and teams with respect to the instructor (presenter). As can be seen in the image, the meeting host or instructor 621 receives high gaze attention from the participants in the form of an inflated heatmap. In contrast, it can also be seen that the most engaging team 623, receives a high gaze attention heatmap showing the interest of certain teams which participates so much in the session that they attract attention both from the instructor as well as other teams present in the training session. Overall FIG. 6C shows comparative statistics over time on user-defined regions of interests which means the users have full control over the system which ensures customized attention estimation in pre-defined region of interest.

Regarding FIG. 6D, the live video stream can be augmented, using the attention points detector 419, with direction of attention lines 631 for each student.

Some conventional gaze tracking systems are only able to determine the gaze direction. This is based on checking the facial orientation and the eye pupil location to determine the gaze angle in terms of yaw, pitch, and roll angles. Typical gaze tracking systems often require a calibration step, where the user is asked to look at various points before usage of such a system. Also, such gaze tracking systems are constrained, in the sense that these systems are designed to monitor the gaze of one person when the person is well situated within the confined space of monitoring for the gaze tracking system. An example of such a system is a driver attention or fatigue detection system in vehicles where the system is expected to monitor the gaze of the driver seated on the driving seat.

In contrast, the disclosed system does not require any calibration system. The disclosed system can work well from a 3rd person viewpoint as well as CCTV viewpoint. The disclosed system also provides the gaze point (the target object) at which the person is looking and is not limited to just the direction of the gaze.

Unlike many conventional systems that rely on depth modality for attention estimation, the disclosed system operates entirely on 2D data. By eliminating depth data, it reduces the complexity and resource requirements, making the system more efficient and versatile for deployment in various environments.

The disclosed system uses a multicamera network to capture data from multiple viewpoints, which enhances its coverage and robustness. While doing so, the system delivery processing speed stays at an optimal level, which assures the system's scalability and capability for real-world deployment and application delivery.

The disclosed system incorporates back-of-the-head detection (BoH). This ensures that individuals with their faces turned away from the camera are still accounted for in the attention estimation process, providing a more comprehensive analysis compared to systems that rely solely on frontal face detection.

The disclosed system uses custom-trained face detector models specifically designed to handle diverse real-world challenges. These models excel at detecting tiny, small, or large faces in varying lighting conditions, such as low-light or well-lit environments, making the system highly adaptable to settings like classrooms or retail shops/malls.

Overall, and above all, the disclosed system focuses on practical deployment by optimizing for accuracy and functionality in diverse environments while maintaining processing efficiency. This trade-off makes it a viable solution for real-world applications like education and retail, where reliability and adaptability are critical.

An aspect is a method of attention detection and tracking, that includes extracting multiple information from a scene in which a person is viewing, wherein the scene is captured through various types of cameras in a static or continuous stream; pinpointing the person's attention to a target gaze point that he or she is looking at in the scene, thereby determining the specific point or area the person is looking at in an image/scene.

An aspect is a computer-implemented method for attention analysis in a video stream, that includes capturing the video stream from a specified source, including one of Real Time Streaming Protocol (RTSP) camera or offline video; defining Regions of Interest (ROIs) for custom attention estimation and tracking, including specific areas for teacher, student, and book reading, note taking; identifying and tracking of persons within the defined ROIs while employing specific object detection techniques, wherein the detection techniques includes the detection of objects in the surroundings, distance-invariant person's face detection, gaze points extraction and attention target mapping using an attention computation algorithm.

An aspect is a computer-implemented method, wherein the conducting identification and tracking of persons within the defined ROIs using object detection and tracking techniques, further including methods for handling occlusions, extracting gaze points from video streams and mapping them to specific attention targets such as product labels, and advertisements using attention computation algorithms in retail settings.

An aspect is a system, that includes an attention tracking module to determine a point of focus of detected persons with a focus on publishing real-time analytics, wherein the analytics determines attention direction, student count, teach-student engagement, and attention scores, wherein the attention analytics are broadcasted through a Pub/Sub streaming multi-camera network, purposefully built for continuous monitoring and tracking of the attention of the detected multiple persons, and played back functionality in a dashboard application.

An aspect is a system, that includes a generic ROI-based people and object detection module to associate objects and attention points, compute an aggregate attention score, and conduct continuous analytics streaming; multiple AI models, trained on custom datasets (western as well as Arab regions) including person detectors, face region detectors, gaze or attention points extractors; and an overall attention computation algorithm configured to continuously produce attention scores in a teacher-student learning environment.

An aspect is a system, that includes a video streaming module for capturing video content from a variety of sources, including local files and RTSP links; Real-time Region of Interest (ROI) selector for targeted attention analysis, including predefined areas for students and teachers; object detection algorithms to identify and track individuals within the selected ROIs; gaze detection module to determine a focus point of persons within the video stream; a publishing module for transmitting attention analytics, including gaze-at-teacher, student count, and attention scores, to an external dashboard system, wherein the dashboard system is configured with a capability to be customised based on requirements.

An aspect is a system, that includes a branch controller to orchestrate various branches of an attention estimation system architecture for real-time and offline attention estimation; the branches include a Face branch, a Scene/image, attention objects, Person detection, head positions localisation, gaze points extraction in an attention spectrum; wherein controller further performs continuous attention computation for real-time and offline attention analytics.

An aspect is and attention detection and tracking system that can run continuously in real-time indefinitely or for a specific period of time on hardware, with multiple ROIs,

An aspect is a VATAS system having a full-fledged distributed streaming architecture that is deployed in a multiple-camera network environment with an acceptable FPS (Frames per Second) streaming,

An aspect is a method, further including computing a personalized attention score for an individual student; and computing an overall attention score for a group of students in a classroom environment.

An aspect is a method, further including computing an impression score and dwell time of person visiting a retail outlet, thereby identifying interesting objects/racks based on the person's gaze and providing further analytics for store optimization.

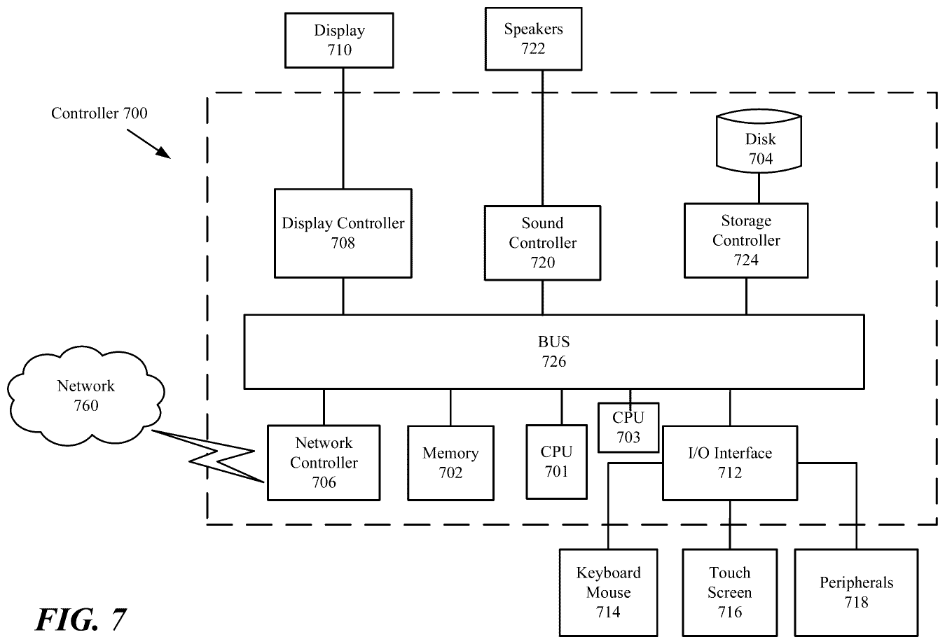

Next, further details of the hardware description of the computing environment according to exemplary embodiments is described with reference to FIG. 7. In FIG. 7, a controller 700 is described is representative of the system 100 of FIG. 1 in which the controller is a computing device which includes a CPU 701 which performs the processes described above/below. The process data and instructions may be stored in memory 702. These processes and instructions may also be stored on a storage medium disk 704 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 701, 703 and an operating system such as Microsoft Windows 10, Microsoft Windows 11, UNIX, LINUX, Apple MAC-OS and other systems known to those skilled in the art.

The hardware elements in order to achieve the computing device may be realized by various circuitry elements, known to those skilled in the art. For example, CPU 701 or CPU 703 may be a Xenon or Core processor from Intel of America or an Opteron processor from AMD of America, or may be other processor types that would be recognized by one of ordinary skill in the art. Alternatively, the CPU 701, 703 may be implemented on an FPGA, ASIC, PLD or using discrete logic circuits, as one of ordinary skill in the art would recognize. Further, CPU 701, 703 may be implemented as multiple processors cooperatively working in parallel to perform the instructions of the inventive processes described above.

The computing device in FIG. 7 also includes a network controller 706, such as an Intel Ethernet PRO network interface card from Intel Corporation of America, for interfacing with network 760. As can be appreciated, the network 760 can be a public network, such as the Internet, or a private network such as an LAN or WAN network, or any combination thereof and can also include PSTN or ISDN sub-networks. The network 760 can also be wired, such as an Ethernet network, or can be wireless such as a cellular network including EDGE, 3G, 4G, or 5G wireless cellular systems. The wireless network can also be WiFi, Bluetooth, or any other wireless form of communication that is known.

The computing device further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the computing device such as Sound Blaster X-Fi Titanium from Creative, to interface with speakers/microphone 722 thereby providing sounds and/or music.

A general purpose storage controller 724 connects the storage medium disk 704 with communication bus 726, which may be an ISA, EISA, VESA, PCI, or similar, for interconnecting all of the components of the computing device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

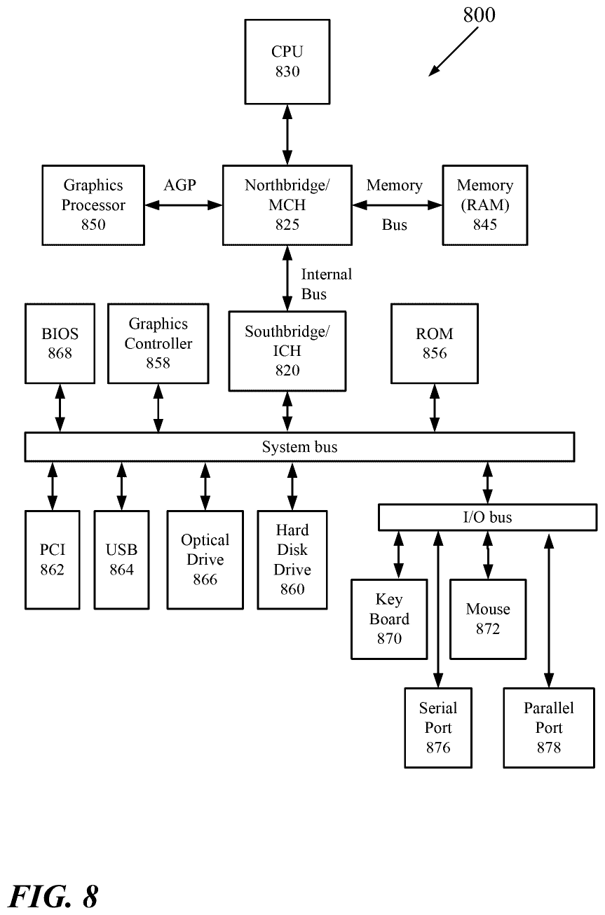

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 8.

FIG. 8 shows a schematic diagram of a data processing system, according to certain embodiments, for performing the functions of the exemplary embodiments. The data processing system is an example of a computer in which code or instructions implementing the processes of the illustrative embodiments may be located.

In FIG. 8, data processing system 800 employs a hub architecture including a north bridge and memory controller hub (NB/MCH) 825 and a south bridge and input/output (I/O) controller hub (SB/ICH) 820. The central processing unit (CPU) 830 is connected to NB/MCH 825. The NB/MCH 825 also connects to the memory 845 via a memory bus, and connects to the graphics processor 850 via an accelerated graphics port (AGP). The NB/MCH 825 also connects to the SB/ICH 820 via an internal bus (e.g., a unified media interface or a direct media interface). The CPU Processing unit 830 may contain one or more processors and even may be implemented using one or more heterogeneous processor systems.

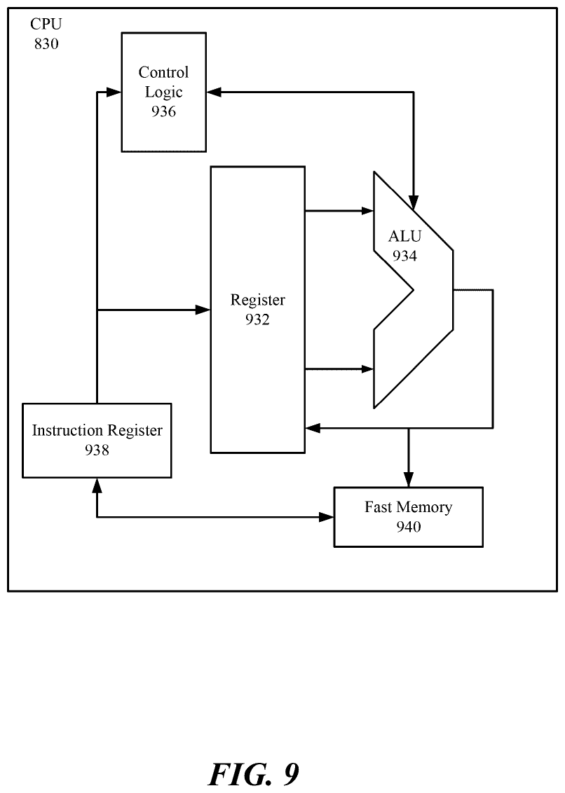

For example, FIG. 9 shows one implementation of CPU 830. In one implementation, the instruction register 938 retrieves instructions from the fast memory 940. At least part of these instructions are fetched from the instruction register 938 by the control logic 936 and interpreted according to the instruction set architecture of the CPU 830. Part of the instructions can also be directed to the register 932. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 934 that loads values from the register 932 and performs logical and mathematical operations on the loaded values according to the instructions. The results from these operations can be feedback into the register and/or stored in the fast memory 940. According to certain implementations, the instruction set architecture of the CPU 830 can use a reduced instruction set architecture, a complex instruction set architecture, a vector processor architecture, a very large instruction word architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 8, the data processing system 800 can include that the SB/ICH 820 is coupled through a system bus to an I/O Bus, a read only memory (ROM) 856, universal serial bus (USB) port 864, a flash binary input/output system (BIOS) 868, and a graphics controller 858. PCI/PCIe devices can also be coupled to SB/ICH 888 through a PCI bus 862.

The PCI devices may include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bus through the I/O bus. Other peripherals and devices that can be connected to the SB/ICH 820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

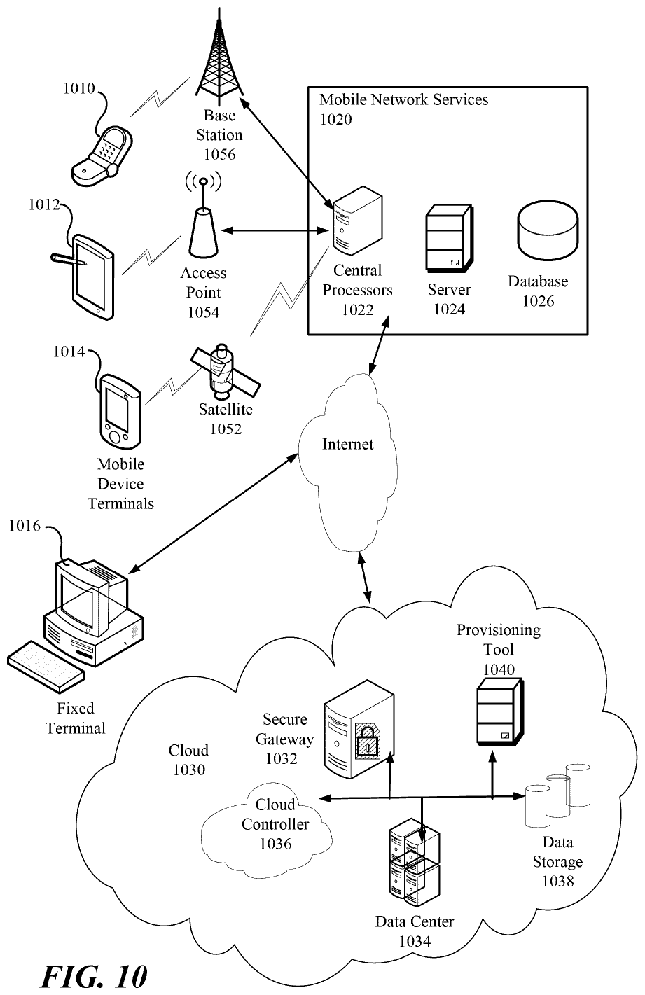

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 10, in addition to various human interface and communication devices (e.g., display monitors, smart phones, tablets, personal digital assistants (PDAs)). More specifically, FIG. 10 illustrates client devices including a smart phone 1011, a tablet 1012, a mobile device terminal 1014 and fixed terminals 1016. These client devices may be commutatively coupled with a mobile network service 1020 via a base station 1056, an access point 1054, a satellite 1052 or via an internet connection. The mobile network service 1020 may comprise central processors 1022, a server 1024 and a database 1026. The fixed terminals 1016 and the mobile network service 1020 may be commutatively coupled via an internet connection to functions in cloud 1030 that may comprise a security gateway 1032, a data center 1034, a cloud controller 1036, a data storage 1038 and a provisioning tool 1040. The network may be a private network, such as the LAN or the WAN, or may be the public network, such as the Internet. Input to the system may be received via direct user input and received remotely either in real-time or as a batch process. Additionally, some implementations may be performed on modules or hardware not identical to those described. Accordingly, other implementations are within the scope that may be disclosed.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A system for attention tracking and analytics, comprising:
a video stream storage device for storing a video stream of a predefined area, the predefined area including at least one person;
a tracking and analysis server configured with
a plurality of object detectors, including
a person detector for detecting person images of the at least one person in the predefined area,
an object detector for detecting objects in the predefined area, and
a gaze module for extracting gaze points and analyzing the gaze points to determine a possible attention target of the at least one person in the person images;
an attention calculation module for continuous tracking of attention direction of the at least one person and real-time determining of an attention score based on the attention target; and
a display device for dynamically displaying the video stream together with attention information, including the attention score, for the at least one person.

2. The system of claim 1, further comprising at least one video camera device for capturing the video stream of the predefined area.

3. The system of claim 1, wherein the display includes a region of interest selection function, for a user to select a region of interest in the predefined area.

4. The system of claim 1, wherein the display device includes an object of interest selection function for designating an object of interest, the system further comprising an object detector, wherein the attention calculation module applies a positive attention point when the gaze module analyzes gaze patterns and determines that a gaze direction is towards the selected object.

5. The system of claim 1, wherein the attention calculation module applies a negative attention point when the gaze module analyzes gaze patterns and determines that a gaze direction of the at least one person is towards a mobile phone as a detected object.

6. The system of claim 5, wherein the display device displays an alert message indicating that the at least one person has attention focused on the mobile phone.

7. The system of claim 1, wherein the attention calculation module applies a negative attention point when the gaze module analyzes gaze patterns and determines that a gaze direction of the at least one person is towards another student for at least a predetermined period.

8. The system of claim 1, wherein the person detector is configured to detect a back-of-the-head of a person,
wherein the gaze module is configured to extract gaze points and determine an attention target from a perspective of the detected back-of-the-head of the person.

9. The system of claim 1, wherein the display device is configured to dynamically display a line indicating the real-time attention direction of the at least one person based on the gaze patterns.

10. The system of claim 1, wherein the gaze module is configured for gaze target prediction to predict the direction of a person gaze, and determine whether the at least one person is focused on a teacher, or on other students, or specific objects, and
wherein the attention calculation module is configured to estimate a degree of student-teacher attention.

11. A computer-implemented method of attention tracking and analytics, comprising:
storing, in a video storage device, a video stream of a predefined area, the predefined area including at least one person;
detecting a person image of the at least one person in the predefined area;
detecting objects in the predefined area;
extracting gaze points and determining a possible attention target of the detected person;
continuously tracking of attention direction of the at least one person;
determining in real time an attention score based on the attention target; and
dynamically displaying, in a display device, the video stream together with attention information, including the attention score, for the at least one person.

12. The computer-implemented method of claim 11, further comprising:
capturing a real time video stream of the predefined area; and
continuously tracking of attention direction of the at least one person in the real time video stream.

13. The computer-implemented method of claim 11, further comprising:
selecting a region of interest in the predefined area; and
continuously tracking of attention direction of the at least one person in the selected region of interest.

14. The computer-implemented method of claim 11, further comprising:
selecting an object of interest;
analyzing gaze patterns of the at least one person;
applying a positive attention point when the analyzing determines that a gaze direction is towards the selected object.

15. The computer-implemented method of claim 11, further comprising:
analyzing gaze patterns of the at least one person;
applying a negative attention point when the analyzing determines that a gaze direction of the at least one person is towards a mobile phone as a detected object.

16. The computer-implemented method of claim 15, further comprising displaying an alert message indicating that the at least one person has attention focused on the mobile phone.

17. The computer-implemented method of claim 11, further comprising:
analyzing gaze patterns of the at least one person;
applying a negative attention point when the analyzing determines that a gaze direction of the at least one person is towards another student for at least a predetermined period.

18. The computer-implemented method of claim 11, further comprising:
detecting a back-of-the-head of a person;
extracting gaze points and determining a possible attention target from a perspective of the detected back-of-the-head of the person using the gaze points.

19. The computer-implemented method of claim 11, further comprising:
dynamically displaying a line indicating the real-time attention direction of the at least one person based on the gaze patterns.

20. The computer-implemented method of claim 11, further comprising:
predicting the direction of a person gaze; and
determining whether the at least one person is focused on a teacher, or on other students, or specific objects; and
estimating a degree of student-teacher attention based on the direction of the person gaze.
